(19) United States
(12) Patent Application Publication
(10) Pub. No.: US 2026/0267389 A1
(43) Pub. Date: Sep. 10, 2026

(54) REAL-TIME POWER MANAGEMENT FOR ON-DIE THERMAL PROTECTION

(71) Applicant: NVIDIA Corporation, Santa Clara, CA (US)

(72) Inventors: Ofek Abadi, Nahariya (IL); Naor Peretz, Kfar Yona (IL)

(21) Appl. No.: 19/069,923

(22) Filed: Mar. 4, 2025

(51) Int. Cl. G06F 1/3206; G06F 1/3287; G06F 1/3296; H01L 23/373

(52) U.S. Cl. CPC G06F 1/3206; G06F 1/3287; G06F 1/3296; H10W 40/253

(57) ABSTRACT

An integrated circuit includes a plurality of thermal sensors integrated within digital domain circuitry and control logic coupled to the plurality of thermal sensors. The control logic retrieves temperature values generated by one or more thermal sensors of the plurality of thermal sensors. The control logic employs the temperature values within a heat-spreading function to determine a time period during which the one or more thermal sensors are to be deactivated and deactivates the one or more thermal sensors for the time period.

### TECHNICAL FIELD

At least one embodiment generally pertains to integrated circuits (ICs) or IC dies, and more specifically, but not exclusively, to real-time power management for on-die thermal protection.

### BACKGROUND

Most modern communication systems include chips that transmit data between each other. Even state of the art chips consume significant amount of power for this purpose, which creates two predominant problems: overheating and wasted power consumption. Because overheating can occur in dynamic hot spots on an integrated chip (IC) or IC die, current integrated circuit technology deploys thousands of thermal sensors across the chip, consuming a non-negligible amount of power. Further, the computing resources are sometimes required to map precise temperatures across all of these sensors on the chip, which adds to an already high number of tasks and processes being performed by the chip, increasing computing demands.

Another use of such an array of thermal sensors is for thermal protection, which is employed to simply indicate whether a certain temperature threshold has been exceeded, thus not requiring a full heat map to track dynamic hot spots. For example, if an on-chip temperature exceeds a particular threshold value associated with a danger region that could, if not addressed, damage the chip, the chip can be designed to take action for reducing the die temperature. Such action may include, for example, lowering frequencies, turning off circuit units, lowering the supply voltage, or event shutting down the chip. Present methods of employing an array (or many arrays) of thermal sensors on an IC or die to provide thermal protection is through a similar approach employed for generating heat maps, which consumes too much power and processing (e.g., system resources) associated with precise thermal tracking.

### BRIEF DESCRIPTION OF DRAWINGS

Various embodiments in accordance with the present disclosure will be described with reference to the drawings, in which:

FIG. 1 is a schematic block diagram of an example system, including an IC or die, implementing real-time power management for on-die thermal protection according to some embodiments;

FIG. 2 is a simplified schematic block diagram of an example set of IC dies together with a spatial grouping of thermal sensors and associated calibration diodes according to at least some embodiments;

FIG. 3 is a graph illustrating temperature regions that can be employed for tracking the temperature of the integrated circuit (e.g., die or chip) and detecting whether that temperature crosses certain thermal threshold values according to some embodiments;

FIG. 4 is a flow chart of an example method for the control logic (or thermal controller) to execute the real-time power management for the on-die thermal protection according to at least some embodiments;

FIG. 5 is a flow chart of an example method for performing the real-time power management for the on-die thermal protection according to at least some embodiments;

FIG. 6A is a flow chart of a method for performing the real-time power management for the on-die thermal protection according to at least some additional embodiments;

FIG. 6B is a flow chart of a method for performing the real-time power management for the on-die thermal protection according to still further embodiments;

FIG. 7A illustrates an example communication system in which the AC-coupled unidirectional (or short-reach) link operates according to at least one embodiment;

FIG. 7B illustrates a block diagram of an example communication system in which the AC-coupled unidirectional (or short-reach) link operates according to at least one embodiment.

FIG. 8 illustrates an example computer system including a spectrum hardware engine and an error correction block according to at least one embodiment;

FIG. 9 is a block diagram of a computing system having two processing devices coupled to each other and multiple networks according to at least one embodiment;

FIG. 10 is a block diagram of a computing system having a central processing unit (CPU) and a graphics processing unit (GPU) in a single integrated circuit according to at least one embodiment; and

FIG. 11 is a block diagram of a computing system having tensor core graphics processing units (GPUs) according to at least one embodiment.

### DETAILED DESCRIPTION

Aspects and embodiments of the present disclosure address the above deficiencies with former thermal protection techniques by designing chip logic to intelligently deactivate the thermal sensors for long periods of time so long as their temperature value readings are sufficiently low. Deactivated thermal sensors conserve a significant amount of power and processing, particularly if the thermal sensors are deactivated (or in low-power mode) for much longer than the thermal sensors are activated (or in normal-power mode). This intermittent deactivation/activation of thermal sensor(s) can be performed because the time (e.g., order of microseconds) required for a thermal sensor to operate and provide a thermal reading is much shorter than the time (e.g., order of milliseconds (ms)) required for silicon material(s) to raise in temperature into a danger zone. In this way, the present embodiments avoid significant additional power consumption and waste of system management resources associated with large thermal sensor arrays when providing thermal protection.

With additional specificity, the present disclosure employs a thermal controller (or other control logic) to activate thermal sensor(s) for a short period of time to get temperature values and to use those temperature values in a heat-spreading function to determine a time period during which the thermal sensor(s) can be deactivated. For example, the heat-spreading function can model characteristics of silicon temperature expansion that includes a time constant of thermal conductivity for silicon. Once the time period is ascertained based on such a function, the thermal controller can deactivate the thermal sensor(s) and wait the time period until reactivating the thermal sensors(s). Once reactivated, the process can cycle again in response to a subsequent thermal read operation, e.g., by determining an updated time period based on newly read temperature values, deactivating the thermal sensor(s), and waiting the updated time period before reactivating the thermal sensor(s).

Further, to improve full-chip integration and accuracy of the disclosed thermal protection optimization, the thermal controller can perform the above-described method on a group of co-located thermal sensors. In this way, only an average value of the temperature values read out of all of the group of sensors need be employed, which integrates these temperature values over a larger area of the chip. Further, because the average value smooths out mismatched temperature values between sensors, the ultimate time period calculated can be more accurate.

Therefore, advantages of the ICs, dies, systems, and methods implemented in accordance with some embodiments of the present disclosure include providing thermal protection with array(s) of thermal sensors while activating the thermal sensors for only a fraction of overall time during which the chip or system temperature is monitored. Additional advantages include significantly reducing power consumption and processing resources employed to provide such thermal protection. Other advantages will be apparent to those skilled in the art of thermal sensor design and thermal protection within digital domains, as will be discussed hereinafter.

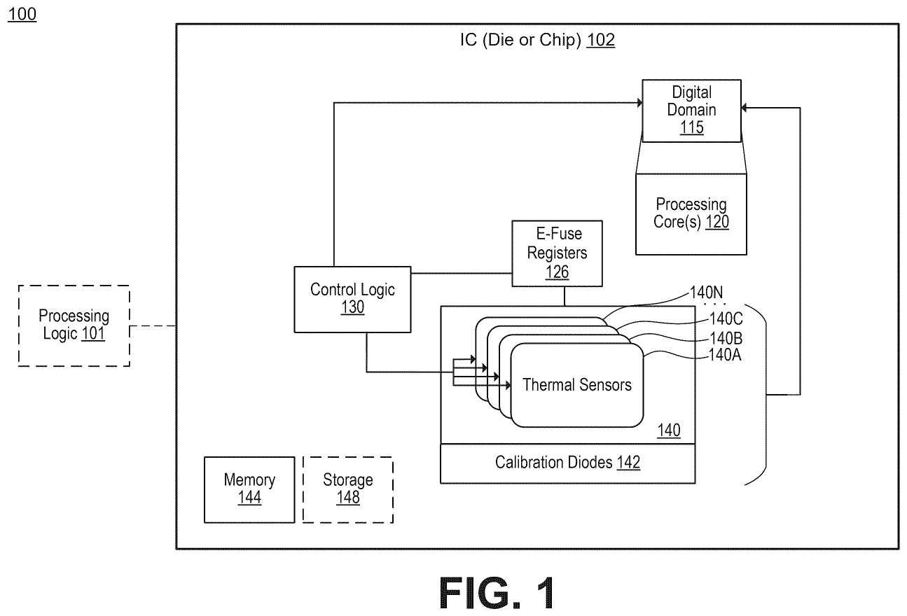

FIG. 1 is a schematic block diagram of an example system 100, including an integrated circuit 102 (e.g., a die or chip), implementing real-time power management for on-die thermal protection according to some embodiments. In such embodiments, the system 100 includes the integrated circuit 102 and optionally also includes processing logic 101 located off-chip of the integrated circuit 102. The integrated circuit 102 can be a die or chip that is to be protected from overheating to dangerous temperature levels. In at least some embodiments, the integrated circuit 102 is or includes a central processing unit (CPU), a graphics processing unit (GPU), or a data processing unit (DPU), as will be discussed in more detail.

In at least some embodiments, the integrated circuit 102 includes digital domain circuitry 115, one or more processing cores 120, memory 144, and optional storage 148. In some embodiments, the processing core(s) 120 include at least a portion of the digital domain circuitry 115. The integrated circuit 102 can also include e-fuse registers 126 and control logic 130.

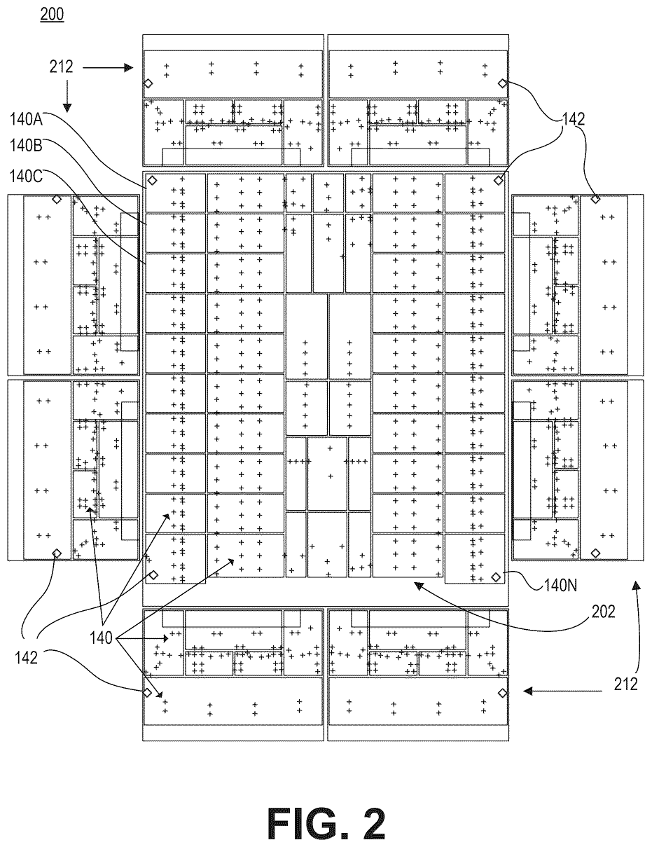

In at least some embodiments, the integrated circuit 102 includes a plurality of thermal sensors 140 and a plurality of calibration diodes 142. In embodiments, the plurality of thermal sensors 140 and the plurality of calibration diodes 142 are integrated within the digital domain circuitry 115 across the integrated circuit 102 (see FIG. 2). The control logic 130 can be integrated within one of the processing core(s) 120. In some embodiments, the calibration diodes 142 are coupled to the control logic 130 and are useable for accurate thermal sensing during a thermal calibration mode, e.g., when the thermal sensors 140 are activated for calibration.

In various embodiments, the storage 164 includes instructions that are executable by a processing device, such as the control logic 130 (or a controller), out of the memory 144 to perform functions associated with thermal sensing and tracking. In some embodiments, the control logic 130 is at least partially instantiated as hardware logic and/or as firmware. The control logic 130 can be configured to activate the plurality of thermal sensors 140 or a group of co-located thermal sensors so that temperature values can be read out of the activated thermal sensors. The plurality of thermal sensors 140 (or a group of co-located thermal sensors) can provide temperature values through hardware, firmware, or a combination thereof. Thus, the thermal sensors 140 can perform an analog thermal measurement to determine these temperature values.

During activation, according to some embodiments, these temperature values are stored in the memory 144, which the control logic 130 (or processing logic 101) can read out in order to employ the temperature values within a heat-spreading function to determine a time period during which the thermal sensors 140 are to be deactivated. The control logic 130 can store this time period in the memory 144 to be accessed during deactivation of the thermal sensors 140. In varying embodiments, the heat-spreading function is a linear extrapolation that employs a single thermal time constant, a piecewise linear function that employs multiple thermal time constants for different temperature regions, or an explicit continuous function that tracks a non-linear path between temperature and time.

The control logic 130 may also record or store (e.g., in the e-fuse registers 126) calibrated temperature values from the plurality of calibration diodes 142 and calibrated thermal values from the plurality of thermal sensors 140 obtained during the calibration mode. In other embodiments, these calibrated temperature values from the plurality of calibration diodes 142 and calibrated thermal values from the thermal sensors 140 are provided to the control logic 130 (or other processing device) to be stored in the memory 160 and/or the storage 164.

In some embodiments, the plurality of e-fuse registers 126 are coupled to the plurality of thermal sensors 140. In these embodiments, the control logic 130 writes calibrated thermal values to the plurality of e-fuse registers 126 for use by the plurality of thermal sensors 140 during functional mode, e.g., upon being activated by the control logic 130.

In some embodiments, the control logic 130 (or processing logic 101) groups a subset of the plurality of thermal sensors according to proximity (e.g., are co-located) to generate a plurality of groups of thermal sensors, e.g., a first group 140A, a second group 140B, a third group 140C, and so forth through to an Nth group 140N of the plurality of thermal sensors 140. In these embodiments, the control logic 130 (or processing logic 101) determines a spatially average temperature value of a group of thermal sensors, which can be repeated for each group of thermal sensors. The control logic 130 (or processing logic 101) can employ the spatially average temperature value to determine the time period during which the group of co-located thermal sensors are to be deactivated, as will be discussed in more detail.

FIG. 2 is a simplified schematic block diagram of an example set of IC dies 200 together with a spatial grouping of thermal sensors 140 and associated calibration diodes 142 according to at least some embodiments. In various embodiments, each integrated circuit 102 (e.g., die or chip) includes the plurality of thermal sensors 140 (marked as a +) distributed throughout the digital domain circuitry 115, the latter of which is not illustrated for purposes of simplicity of illustration. In some embodiments, each integrated circuit 102 (or system) also includes the plurality of calibration diodes 142 and can include the set of IC dies 200.

High-end and modern communication systems are anticipated to have a considerable chip area. In such systems, if each digital thermal sensor 140 is small enough in area and easily integrated, a large number of the thermal sensors 140 may be instantiated over the chip area in negligible integration effort. Moreover, on the full chip level, one can determine that each digital unit will be integrated with one or more thermal sensors 140. Since the number of thermal sensors may be larger than the required thermal spatial resolution, the array of sensors can be divided into local groups or subsets of co-located thermal sensors 140. In this way, an effective spatial resolution is defined for a particular thermal solution on the full chip level.

In some embodiments, as illustrated in FIG. 2, the set of IC dies 200 includes a main die 202 (in the middle) and eight auxiliary dies 212 coupled around a periphery of and to the main die, although different die arrangements are envisioned. Each die or all of the dies as a group may be comparable to the integrated circuit 102 discussed with reference to FIG. 1. For example, not all of these dies need to be activated at the same time. In one example, thermal sensors 140 of the main die 202 are activated with thermal sensors 140 of other main dies at the wafer level, or only a subset of such thermal sensors 140 that are most spatially proximate to each other are activated. Further, the thermal sensors 140 of each auxiliary die 212 can be activated alone or together with others of the auxiliary dies.

As was discussed, the integrated circuit 102 may be segmented into a plurality of subsets or groups of co-located thermal sensors 140, each group being in relative proximity. Only by way of example, this plurality of groups may include a first group 140A, a second group 140B, a third subset 140C, and so forth through to an Nth subset 140N of the plurality of thermal sensors 140. Further, each subset may also be associated with a nearest or closest calibration diode 142 In some embodiments, the control logic 130 determines and stores a calibration temperature value (e.g., juncture temperature value) in the e-fuse registers 126 (or the memory 160 and/or the storage 164) in relation to each group of the thermal sensors 140, e.g., 140A . . . 140N. This calibration temperature value may then be used during the functional mode to map an output of a respective subset of the thermal sensors 140 to an actual temperature.

In some embodiments, grouping the thermal sensors 140 is predefined based on a thermal simulation performed pre-silicon before tape out. In some embodiments, the grouping of thermal sensors 140 as a subset or group does not require some arbitrary minimum or maximum number of sensors, but rather, may be based on topology analysis in which nearby sensors are grouped together in a logical way. For example, a sufficient number of thermal sensors 140 in each subset may enable averaging to a more accurate temperature value while being located in a geographically small enough area that differences in actual temperature across the geographic area are also small. Geographic relevance may be encouraged due to some temperature and process variations across a die or chip.

Further, an average temperature value of all of the thermal sensors 140 or a group of the plurality of thermal sensors 140 may be employed to determine the time period of deactivation since, for thermal protection, precise thermal mapping is not necessary. For example, the disclosed algorithms can be configured to result in a binary indication such as whether the temperature across the integrated circuit 102 exceeds a specific threshold value.

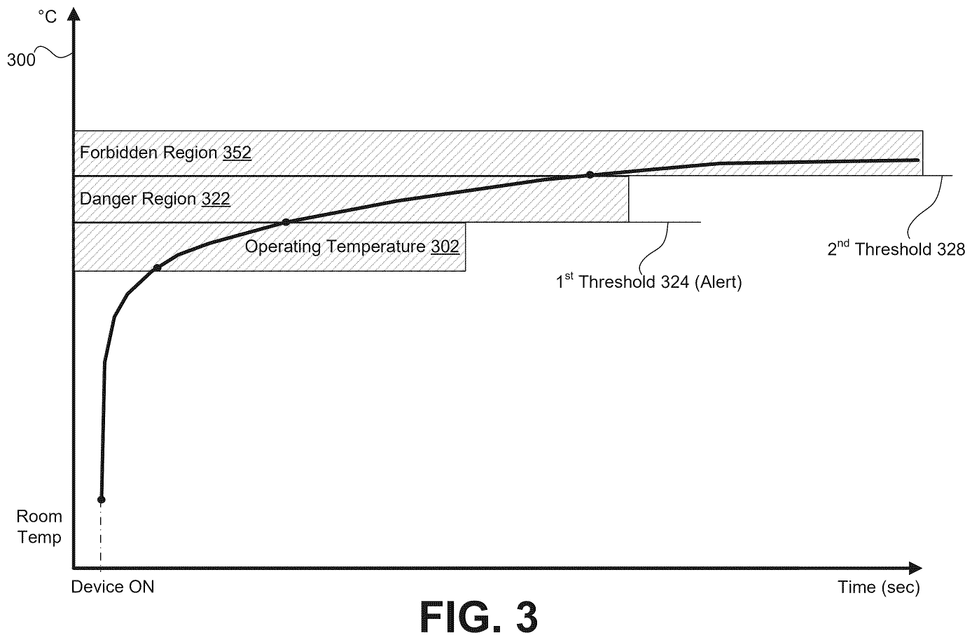

FIG. 3 is a graph 300 illustrating temperature regions that can be employed for tracking the temperature of the integrated circuit 102 (e.g., die or chip) and detecting whether that temperature crosses certain thermal threshold values according to some embodiments. In embodiments, for example, when a system that includes the integrated circuit 102 is turned on, the integrated circuit 102 starts to heat exponentially over time until its temperature reaches an expected operating temperature 302. If integrated circuit 102 is well behaved and the thermal control of the integrated circuit 102 is working properly, the die temperature will not exceed the expected operating temperatures. In some situations, however, thermal control (e.g., employed by the control logic 130 or a controller) malfunctions and so certain thermal thresholds can be defined ahead of time that cannot be exceeded. In typical cases, if the die temperature exceeds a thermal threshold, the die temperature will keep its exponential growth until the temperature saturates, which can damage the chip and/or cause improper chip functionality.

Thus, in some disclosed embodiments, a first threshold value 224 can be associated with entering a danger region 322 that lies above a range of the operating temperature 302. The danger region 322 can be associated with a temperature range that is approaching problematic (e.g., damage-causing) temperature values while still avoiding such damage. Further, in these and other embodiments, a second threshold value 328 can be associated with entering a forbidden region 352, which can define a range of temperature values that are likely to cause damage or at least chip malfunctions, and within which region the die temperature would saturate.

The temperature plot in the graph 300 also reflects a time gradient of temperature on a silicon-based die. In various embodiments, a time constant of temperature change varies with time. The derivative of the temperature plot can be defined as local time constant for thermal propagation. Indeed, this value can be understood as a boundary for such a time constant since, in a functioning die or chip, a proper thermal solution within the control logic 130 should ensure the die temperature remains in a region of the operating temperature 302.

More specifically, if the thermal control solution(s) work properly, thermal protection is would waste significant power and resources, as what is derived from the plurality of thermal sensors 140 are indications for being below the forbidden region (for example, binary result of thermalₜₒₒ_{ₕₒₜ}=0). For the integrated circuit 102 (FIG. 1 and FIG. 2), approximately several milliamps (mA) per thermal read times approximately a thousand sensors would result in a few Watts in power consumed as well as a dedicated part of the management computing power. Because determining the precise temperature of each thermal sensor 140 is unnecessary, and thus just determining whether the die temperature exceeds a specific threshold is sufficient, operating the sensors 140 in the integrated circuit 102 to measure their real-time temperature wastes resources and provides much more information than needed for thermal-protection.

At least some of the disclosed embodiments, which will be explained in more detail below, are intended to exploit the fact that the control logic 130 (or controller) only needs to know whether the die temperature exceeds a specific threshold value. Thus, by reducing time periods of activating the thermal sensors 140 so that the thermal sensors 140 remain deactivated most of the time, significant power and processing resources are conserved while still ensuring that the control logic 130 gets the right indication needed to operate such thermal protection. As explained herein, thermal protection can be performed at a sub-system or sub-chip level, as associated with a group of co-located thermal sensors, such as at the main die 202 or at an auxiliary die 212 of the set of IC dies (see FIG. 2).

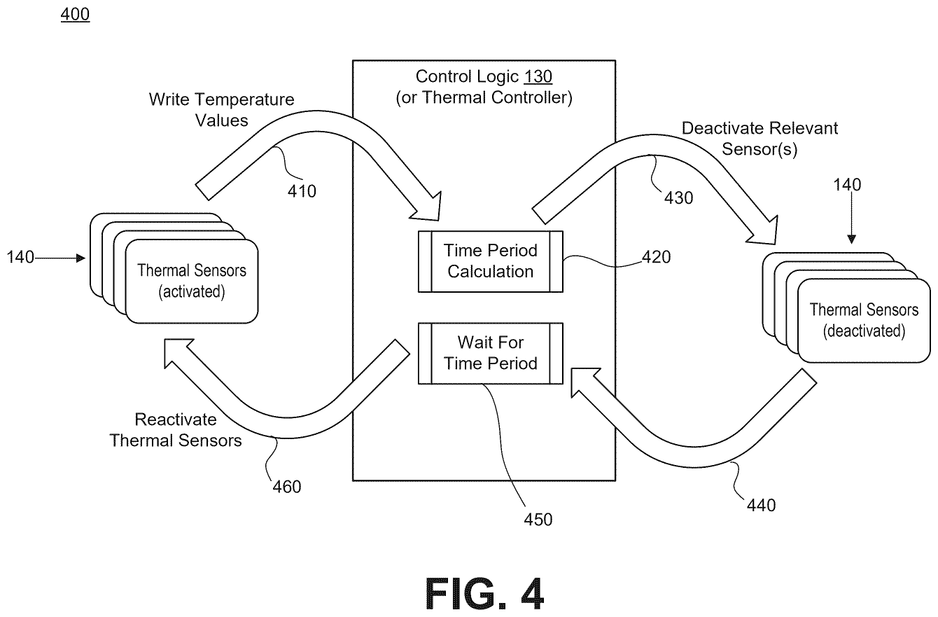

FIG. 4 is a flow chart of an example method 400 for the control logic (or thermal controller) to execute the real-time power management for the on-die thermal protection according to at least some embodiments. The method 400 can be performed by processing logic comprising hardware, software, firmware, or any combination thereof. For example, the method 400 can be performed by the control logic 130 (and/or the processing logic 101) in conjunction with the thermal sensors 140 on the integrated circuit 102 (see FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some embodiments, the plurality of thermal sensors 140 are capable of producing a thermal result with a time constant of approximately several microseconds. As can be seen in FIG. 3, however, temperature change of the silicon-based die or chip (e.g., the integrated circuit 102) can be determined as a derivative of the temperature plot and varies based on architecture and operating conditions of the integrated circuit 102. The time constant of silicon temperature spread is bounded by τ_{silicon}≅1° C./msec. This means that the silicon thermal conductivity is limited to heating by 1°° C. at 1 ms. Since the slope of the graph in FIG. 3 is not constant, the limit value of τ_{silicon} is reached where the slope is maximal. This assumption was used to develop an algorithm for optimizing the cost of the thermal sensor management that reduces the time during which the thermal sensors 140 are active and keeps the probability for thermal violation at approximately zero. In disclosed embodiments, the time during which the thermal sensors 140 are deactivated can be maximized by determining a time limit for a thermal event and using this information for the next activation of the sensor. Maximization of deactivation time can be performed cyclically so that a time period for deactivating the thermal sensors 140 can be calculated based on up-to-date thermal readings from the plurality of thermal sensors 140.

With reference to FIG. 4, at operation 410, following activation of the thermal sensors 140, the thermal sensor 140 can write their temperature values to the memory 144 (or the e-fuse registers 126), which are accessible by the control logic 130.

At operation 420, the processing logic determines or calculates a time period, using a heat-spreading function, that specifies how long the thermal sensors 140 are to be deactivated. The heat spreading function can model characteristics of silicon temperature expansion that include a time constant of thermal conductivity for silicon. The heat spreading function can also be configured to output the time period that, in response to a failure of thermal control on the integrated circuit 102, would pass before a temperature sensed by the thermal sensors 140 reaches a threshold value that exceeds the normal operating temperature 302 (FIG. 3). In some embodiments, the processing logic makes the threshold value selectable between a danger region associated with a thermal alert or a forbidden region associated with a final thermal threshold. In embodiments, the processing logic (e.g., the control logic 130 or thermal controller) is programmable to set the threshold value based on one of a danger region associated with a thermal alert or a forbidden region associated with a final thermal threshold (see FIG. 3).

At operation 430, the processing logic deactivates the thermal sensors 140, e.g., those that were previously activated.

At operation 440, the processing logic optionally receives confirmation that the thermal sensors 140 have been deactivated.

At operation 450, the processing logic waits for the time period, which was calculated at operation 420, to expire.

At operation 450, the processing logic, in response to expiration of the time period determined at operation 440, reactivates the thermal sensors 140. The processing logic can then wait for a subsequent thermal read operation, at which time the method 400 restarts at operation 410 for the next iteration of the cycle of activation and deactivation of the thermal sensors 140.

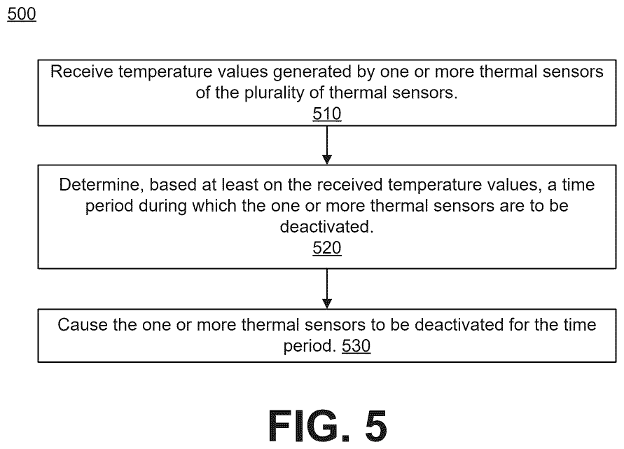

FIG. 5 is a flow chart of an example method 500 for performing the real-time power management for the on-die thermal protection according to at least some embodiments. The method 500 can be performed by processing logic comprising hardware, software, firmware, or any combination thereof. For example, the method 500 can be performed by the control logic 130 on the integrated circuit 102 (see FIG. 1). The method 500 can also be performed by the processing logic 101 (located off-chip of the integrated circuit 102) in other embodiments. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, the processing logic retrieves or receives temperature values generated by one or more thermal sensors of the plurality of thermal sensors 140. Although use of a single sensor is possible, it is more likely that at least a co-located group of thermal sensors or other subset of thermal sensors so that an average temperature value can represent a die or chip in performing the method 500, which can result in a more efficient and accurate reading.

At operation 520, the processing logic determining, based at least on the retrieved (or received) temperature values, a time period during which the one or more thermal sensors are to be deactivated. For example, the processing logic can employ the temperature values within a heat-spreading function (or similar function) to determine the time period.

At operation 530, the processing logic causes the one or more thermal sensors to be deactivated for the time period. In other embodiments, the processing logic directly deactivates the one or more thermal sensors for the time period.

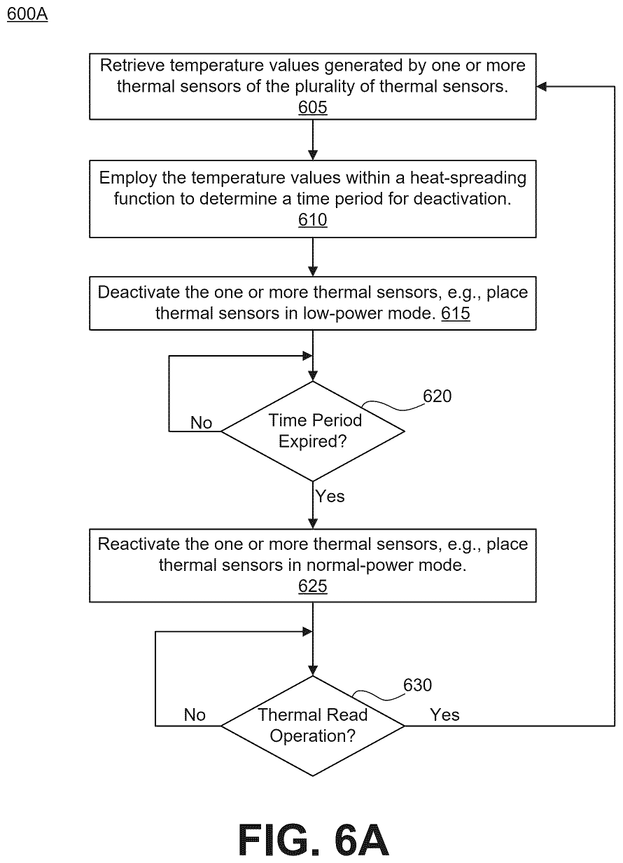

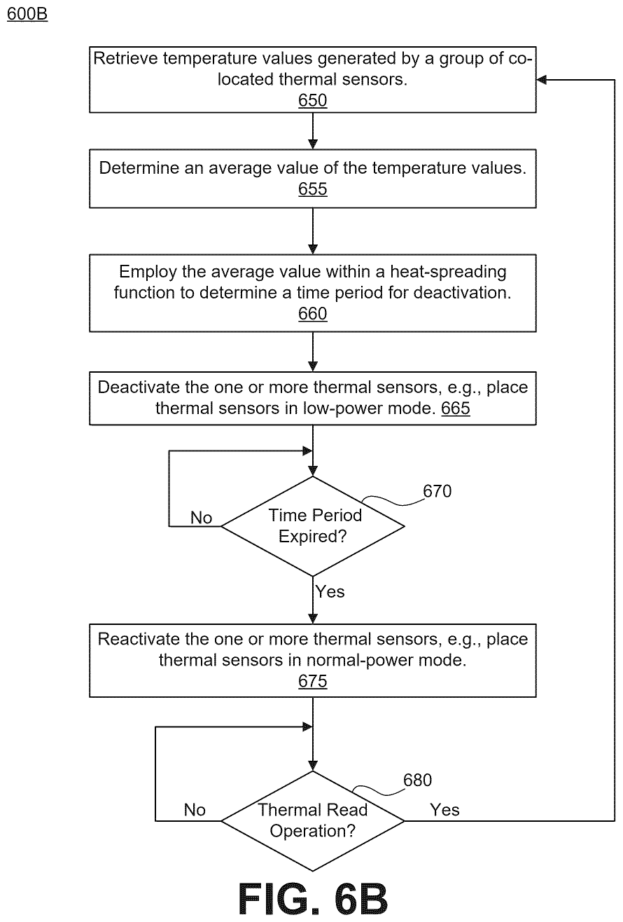

FIG. 6A is a flow chart of a method 600A for performing the real-time power management for the on-die thermal protection according to at least some additional embodiments. The method 600A can be performed by processing logic comprising hardware, software, firmware, or any combination thereof. For example, the method 600A can be performed by the control logic 130 on the integrated circuit 102 (see FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 605, the processing logic retrieves temperature values generated (and optionally stored) by the thermal sensor(s) 140.

At operation 610, the processing logic employs the temperature values within a heat-spreading function to determine a time period for deactivation.

At operation 615, the processing logic deactivates the thermal sensors 140, e.g., by placing the thermal sensors 140 in a low-power mode.

At operation 620, the processing logic determines whether the time period has expired, and waits at operation 620 until the time period does expire.

At operation 625, the processing logic reactivates the thermal sensors 140, e.g., places the thermal sensors 140 in a normal-power mode.

At operation 630, the processing logic determines whether a thermal read operation has been performed and waits until such a thermal read operation is completed before returning to operation 605 to continue performing the method 600A. Thus, in embodiments of the method 600A, the processing logic can continue to retrieve the temperature values from the thermal sensors 140, continue to employ the temperature values in the heat-spreading function to determine an updated time period, and continuously cycle the thermal sensors between being deactivated and being reactivated based on the updated time period. The updated time period can range within a plurality of milliseconds while time spent being reactivated can range within a plurality of microseconds to perform thermal read operations.

FIG. 6B is a flow chart of a method 600B for performing the real-time power management for the on-die thermal protection according to still further embodiments. The method 600B can be performed by processing logic comprising hardware, software, firmware, or any combination thereof. For example, the method 600B can be performed by the control logic 130 on the integrated circuit 102 (see FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 650, the processing logic retrieve a plurality of temperature values from a group of co-located thermal sensors of the plurality of thermal sensors 140.

At operation 655, the processing logic determines an average value of the plurality of temperature values.

At operation 660, the processing logic employs the average value within a heat-spreading function to determine a time period during which the group of co-located thermal sensors are to be deactivated.

At operation 665, the processing logic deactivates the group of co-located thermal sensors, e.g., by placing the group of co-located thermal sensors in a low-power mode.

At operation 670, the processing logic determines whether the time period has expired, and waits at operation 670 until the time period does expire.

At operation 675, the processing logic reactivates the group of co-located thermal sensors, e.g., places the group of co-located thermal sensors in a normal-power mode.

At operation 680, the processing logic determines whether a thermal read operation has been performed and waits until such a thermal read operation is completed before returning to operation 650 to continue performing the method 600B. Thus, in embodiments of the method 600B, the processing logic continues to retrieve the temperature values from the thermal sensors, continues to employ the average value, of the plurality of temperature values, in the heat-spreading function to determine an updated time period, and continuously cycles the group of co-located thermal sensors between being deactivated and being reactivated based on the updated time period. The updated time period can range within a plurality of milliseconds while time spent being reactivated can range within a plurality of microseconds to perform thermal read operations.

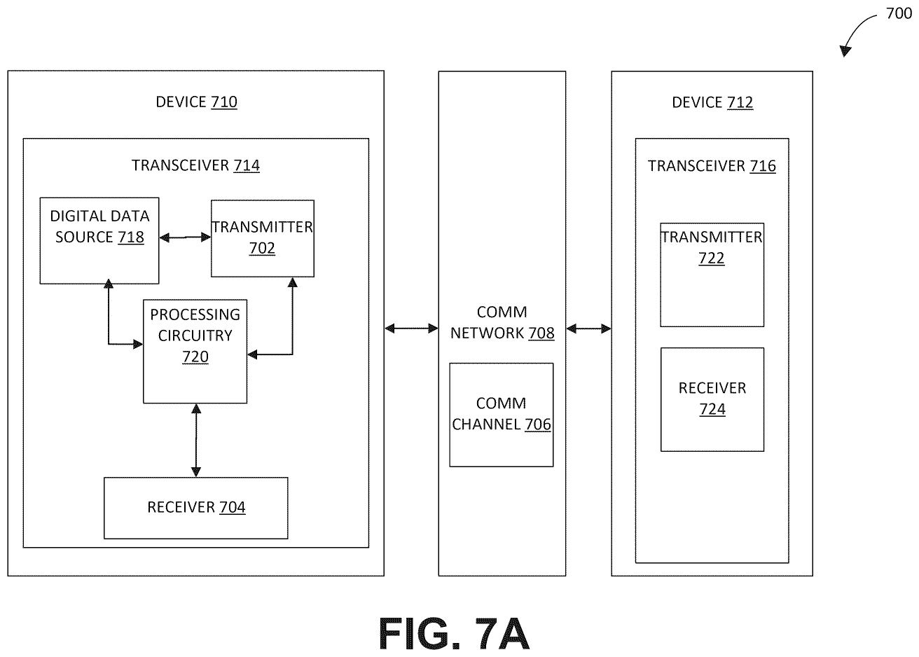

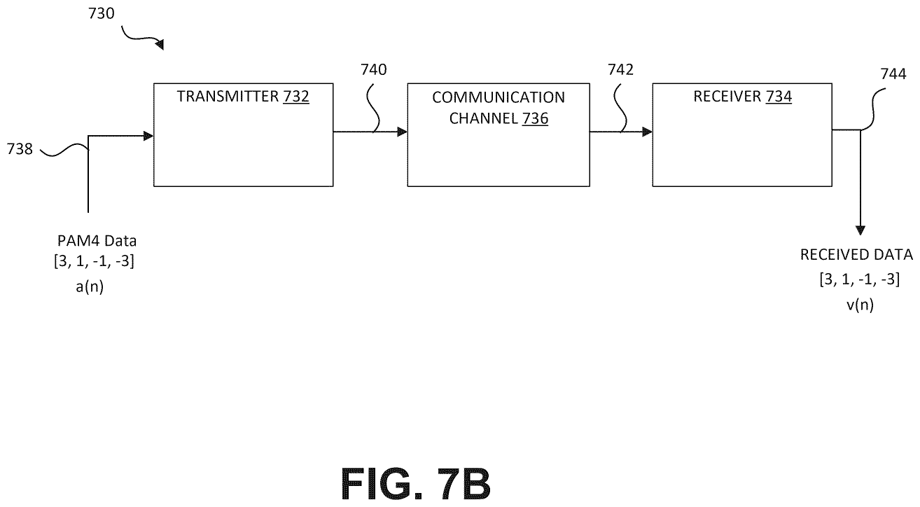

FIG. 7A illustrates an example communication system 700 in which the AC-coupled unidirectional (or short-reach) link operates according to at least one embodiment. The communication system 700 includes a device 710, a communication network 708 including a communication channel 706, and a device 712. In at least one embodiment, the devices 710 and 712 are integrated circuits of a Personal Computer (PC), a laptop, a tablet, a smartphone, a server, a collection of servers, or the like. In some embodiments, the devices 710 and 712 may correspond to any appropriate type of device that communicates with other devices also connected to a common type of communication network 708. According to embodiments, the transmitter 702 and 722 of devices 710 or 712 may correspond to transmitters of a Graphics Processing Unit (GPU), a switch (e.g., a high-speed network switch), a network adapter, a central processing unit (CPU), a data processing unit (DPU), etc.

Examples of the communication network 708 that may be used to connect the devices 710 and 712 include wires, conductive traces, bumps, terminals, optical fibers, or the like. In other embodiments, the communication network 708 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 708 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 708 is a network that enables data transmission between the devices 710 and 712 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver that is composed of an AC-coupled unidirectional (or short-reach) link as described herein. The processing unit can include a CPU, a GPU, a DPU, a network adapter, a network switch, an NVLink switch, or the like. 2436, as described herein.

Other examples for the communication network 708 can include other chip-to-chip or die-to-die interconnects, such as GRS, LPI (low power interface) or LLI (low latency interface).

The device 710 includes a transceiver 714 for sending and receiving signals, for example, data signals. The data signals may be digital or optical signals modulated with data or other suitable signals for carrying data.

The transceiver 714 may include a digital data source 718, a transmitter 702, a receiver 704, and processing circuitry 720 that controls the transceiver 714. The digital data source 718 may include suitable hardware and/or software for outputting data in a digital format (e.g., in binary code and/or thermometer code). The digital data output by the digital data source 718 may be retrieved from memory (not illustrated) or generated according to input (e.g., user input). In various embodiments, system components for thermal protection instantiated on the integrated circuit 102 (e.g., die or chip) discussed with reference to FIG. 1 can also be located on device 710, device 712, communication network 708, or a combination thereof.

The transceiver 714 includes suitable software and/or hardware for receiving digital data from the digital data source 718 and outputting data signals according to the digital data for transmission over the communication network 708 to a transceiver 716 of device 712.

The receiver 704 of device 710 may include suitable hardware and/or software for receiving signals, for example, data signals from the communication network 708. For example, the receiver 704 may include components for receiving processing signals to extract the data for storing in a memory. In at least one embodiment, the transceiver 716 includes a transmitter 722 and receive 724. The transceiver 716 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. In various embodiments, system components for thermal protection instantiated on the integrated circuit 102 (e.g., die or chip) discussed with reference to FIG. 1 can also be located on the transceiver 714, transceiver 716, or a combination thereof.

The processing circuitry 720 may comprise software, hardware, or a combination thereof. For example, the processing circuitry 720 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 720 may comprise hardware, such as an Application-Specific Integrated circuit (ASIC). Other non-limiting examples of the processing circuitry 720 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 720 may be provided on a Printed Circuit Board (PCB) or collection of PCBs. It should be appreciated that any appropriate type of electrical component or collection of electrical components may be suitable for inclusion in the processing circuitry 720. The processing circuitry 720 may send and/or receive signals to and/or from other elements of the transceiver 714 to control the overall operation of the transceiver 714.

The transceiver 714 or selected elements of the transceiver 714 may take the form of a pluggable card or controller for the device 710. For example, the transceiver 714 or selected elements of the transceiver 714 may be implemented on a network interface card (NIC).

The device 712 may include a transceiver 716 for sending and receiving signals, for example, data signals over a communication channel 706 of the communication network 708. The channel 706 can be PCIe, NVLink, Ethernet, InfiniBand, Ground Reference Signal (GRS), Chip-to-Chip (C2C), Die-to-Die (D2D), or the like. The same or similar structure of the transceiver 714 may be applied to transceiver 716, and thus, the structure of transceiver 716 is not described separately.

Although not explicitly shown, it should be appreciated that devices 710 and 712 and the transceiver 714 and transceiver 716 may include other processing devices, storage devices, and/or communication interfaces generally associated with computing tasks, such as sending and receiving data.

FIG. 7B illustrates a block diagram of an example communication system 730 in which the AC-coupled unidirectional (or short-reach) link operates according to at least one embodiment. In the example shown in FIG. 7B, a Pulse Amplitude Modulation level-4 (PAM4) modulation scheme is employed with respect to the transmission of a signal (e.g., digitally encoded data) from a transmitter (TX) 732 to a receiver (RX) 734 via a communication channel 736 (e.g., a transmission medium). The communication channel 706 can be PCIe, NVLink, Ethernet, InfiniBand, GRS, C2C, D2D, or the like. In this example, the transmitter 732 receives an input data 738 (i.e., the input data at time n is represented as “a(n)”), which is modulated in accordance with a modulation scheme (e.g., PAM4) and sends the signal 740 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 736 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 736 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 734 receives an incoming signal 742 over the communication channel 736. The receiver 734 can output a received signal 744, “v(n),” including the set of data symbols (e.g., symbols −3, −1, 1, 3, wherein the symbols represent coded binary data).

In at least one embodiment, the transmitter 732 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 734 can be part of a SerDes IC. The SerDes IC can include a clock-recovery circuit. The clock-recovery circuit can be coupled to an ADC and an equalization block. In another embodiment, the SerDes IC can include additional equalization block before a symbol detector.

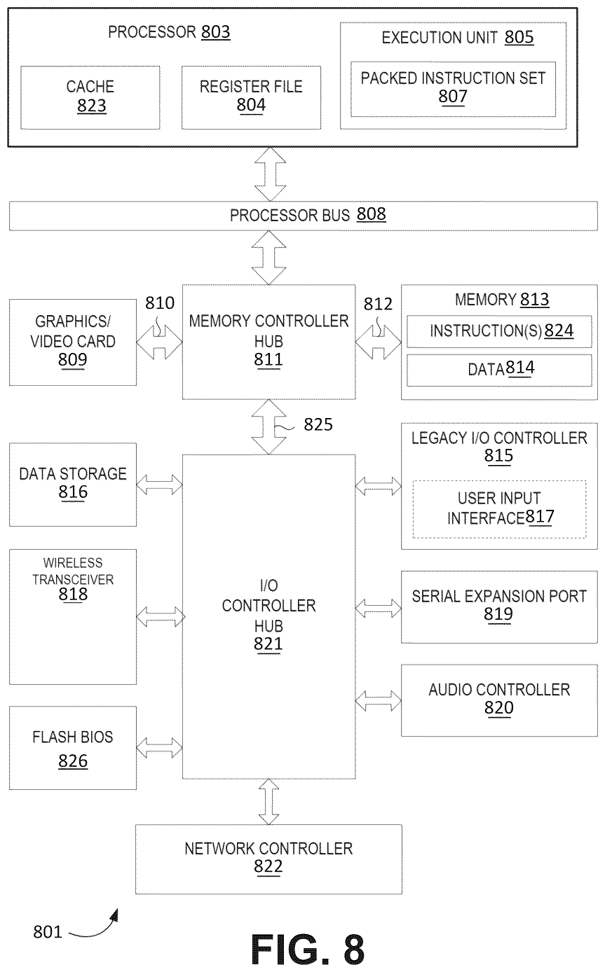

FIG. 8 illustrates an example computer system 801, including an error correction circuit 830, in accordance with at least some embodiments. In at least one embodiment, computer system 801 may be a system with interconnected devices and components, an SOC, or some combination. In at least one embodiment, computer system 801 is formed with a processor 803 that may include execution units to execute an instruction. In at least one embodiment, computer system 801 may include, without limitation, a component, such as a processor 803, to employ execution units including logic to perform algorithms for processing data. In at least one embodiment, computer system 801 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 801 may execute a version of WINDOWS′ operating system available from Microsoft Corporation of Redmond, Wash., although other operating systems (UNIX and Linux, for example), embedded software, and/or graphical user interfaces, may also be used.

In at least one embodiment, computer system 801 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 801 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 801 may include, without limitation, processor 803 that may include, without limitation, one or more execution units 805 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 801 is a single processor desktop or server system. In at least one embodiment, computer system 801 may be a multiprocessor system. In at least one embodiment, processor 803 may include, without limitation, a CISC microprocessor, a RISC microprocessor, a VLIW microprocessor, and a processor implementing a combination of instruction sets, or any other processor device, such as a digital signal processor, for example. In at least one embodiment, processor 803 may be coupled to a processor bus 808 that may transmit data signals between processor 803 and other components in computer system 801.

In at least one embodiment, processor 803 may include, without limitation, a Level 1 (“L1”) internal cache memory (“cache”) 823. In at least one embodiment, processor 803 may have a single internal cache or multiple levels of internal cache. In at least one embodiment, cache memory may reside external to processor 803. In at least one embodiment, processor 803 may also include a combination of both internal and external caches. In at least one embodiment, a register file 804 may store different types of data in various registers including, without limitation, integer registers, floating point registers, status registers, and instruction pointer register.

In at least one embodiment, execution unit 805, including, without limitation, logic to perform integer and floating point operations, also resides in processor 803. Processor 803 may also include a microcode (“ucode”) read only memory (“ROM”) that stores microcode for certain macro instructions. In at least one embodiment, execution unit 805 may include logic to handle a packed instruction set 807. In at least one embodiment, by including packed instruction set 807 in an instruction set of a general-purpose processor 803, along with associated circuitry to execute instructions, operations used by many multimedia applications may be performed using packed data in a general-purpose processor 803. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 806 may also be used in microcontrollers, embedded processors, graphics devices, DSPs, and other types of logic circuits. In at least one embodiment, computer system 801 may include, without limitation, a memory 813. In at least one embodiment, memory 813 may be implemented as a DRAM device, an SRAM device, flash memory device, or other memory devices. Memory 813 may store instruction(s) 824 and/or data 814 represented by data signals that may be executed by processor 803.

In at least one embodiment, a system logic chip may be coupled to a processor bus 808 and memory 813. In at least one embodiment, the system logic chip may include, without limitation, a memory controller hub (“MCH”) 811, and processor 803 may communicate with MCH 811 via processor bus 808. In at least one embodiment, MCH 811 may provide a high bandwidth memory path 812 to memory 813 for instruction and data storage and for storage of graphics commands, data, and textures. In at least one embodiment, MCH 811 may direct data signals between processor 803, memory 813, and other components in computer system 801 and may bridge data signals between processor bus 808, memory 813, and a system I/O 825. In at least one embodiment, a system logic chip may provide a graphics port for coupling to a graphics controller. In at least one embodiment, MCH 811 may be coupled to memory 813 through high bandwidth memory path 812, and graphics/video card 809 may be coupled to MCH 811 through an Accelerated Graphics Port (“AGP”) interconnect 810.

In at least one embodiment, computer system 801 may use system I/O 825 that is a proprietary hub interface bus to couple MCH 811 to I/O controller hub (“ICH”) 821. In at least one embodiment, ICH 821 may provide direct connections to some I/O devices via a local I/O bus. In at least one embodiment, a local I/O bus may include, without limitation, a high-speed I/O bus for connecting peripherals to memory 813, a chipset, and processor 803. Examples may include, without limitation, an audio controller 820, a firmware hub (“flash BIOS”) 726, a wireless transceiver 818, a data storage 816, a legacy I/O controller 815 containing a user input interface 817, a keyboard interface, a serial expansion port 819, such as a USB, and a network controller 822. Data storage 816 may comprise a hard disk drive, a floppy disk drive, a CD-ROM device, a flash memory device, or other mass storage device. In various embodiments, communication between any two short-reach coupled components (such as die-to-die) can include the AC-coupled unidirectional link as described herein.

In at least one embodiment, FIG. 8 illustrates a system, which includes interconnected hardware devices or “chips.” In at least one embodiment, FIG. 8 may illustrate an example SoC. In at least one embodiment, devices illustrated in FIG. 8 may be interconnected with proprietary interconnects, standardized interconnects (e.g., PCIe), or some combination thereof. In at least one embodiment, one or more components of system 802 are interconnected using compute express link (“CXL”) interconnects.

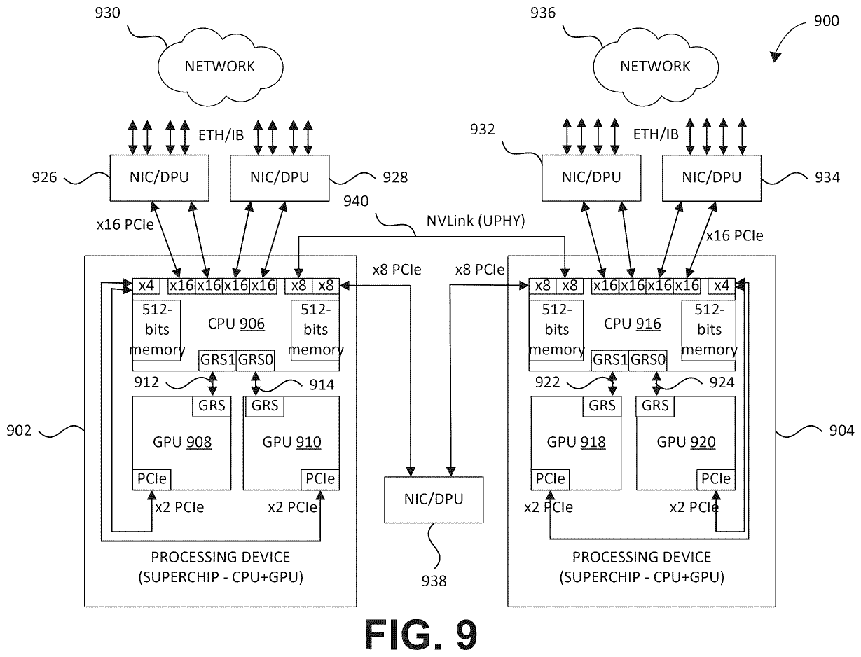

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects. In various embodiments, system components for thermal protection instantiated on the integrated circuit 102 (e.g., die or chip) discussed with reference to FIG. 1 can also be located on the NIC/DPUs of FIG. 9.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938), and a network interface coupled to the processing unit. The network interface can include the operations and functionality of the DPUs described herein.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 6B. The auxiliary device can include a GPU. The auxiliary device can include a DPU. The auxiliary device can include a DPU. The auxiliary device can include accelerator hardware.

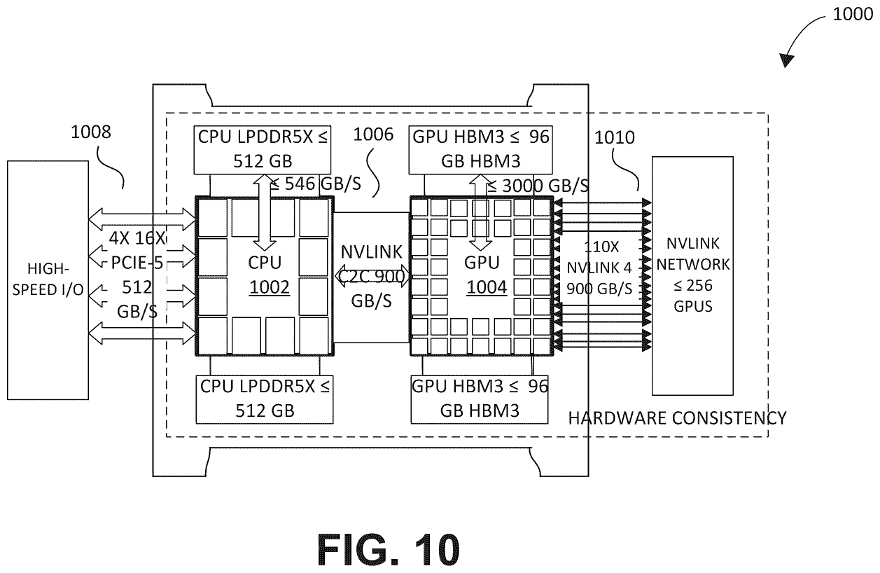

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

The computing system 1000 can include the control logic 130 (or thermal controller) used for the various embodiments described herein with respect to FIG. 1A to FIG. 4. The control logic 130 (or thermal controller) can be implemented in any receiver device of any of the devices described herein.

In at least one embodiment, the computing system 1000 is used for high-speed network communication and includes a processing unit, and a network interface coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device performs the operations described herein with respect to FIG. 1 to FIG. 6B. The auxiliary device can include a GPU. The auxiliary device can include a DPU. The auxiliary device can include a DPU. The auxiliary device can include accelerator hardware.

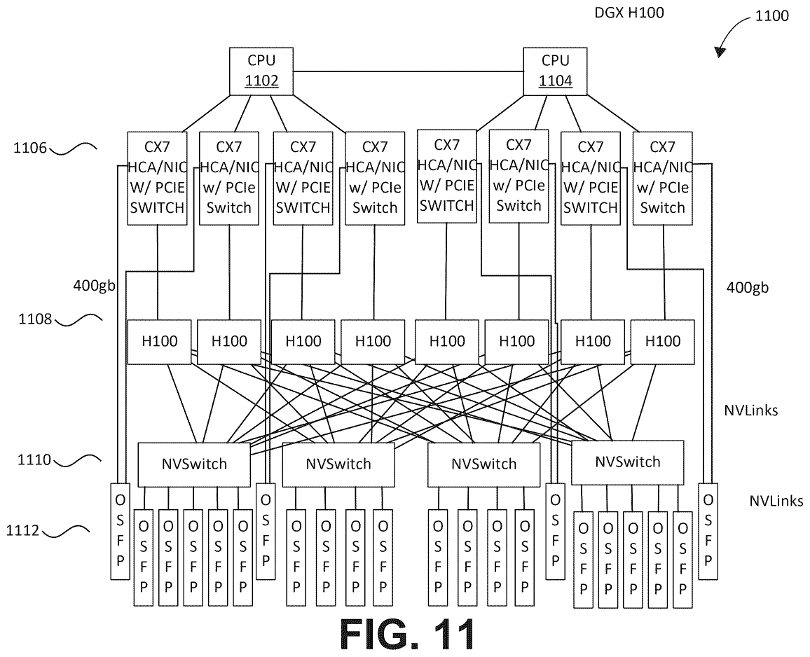

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 1. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1100 can include the various embodiments described herein with respect to FIG. 1 to FIG. 6B. In at least one embodiment, the computing system 1100 is used for high-speed network communication and includes a processing unit (e.g., CPU 1102, CPU 1104, switches 1106, tensor core GPUs 1108, switches 1110, high-speed transceiver modules 1112), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1100 includes a host device and an auxiliary device. The auxiliary device includes a device memory and a processor, communicably coupled to the device memory. The auxiliary device performs the operations described herein with respect to FIG. 1 to FIG. 6B. The auxiliary device can include a GPU. The auxiliary device can include a DPU. The auxiliary device can include a DPU. The auxiliary device can include accelerator hardware.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. An integrated circuit comprising:
a plurality of thermal sensors integrated within digital domain circuitry; and
control logic, coupled to the plurality of thermal sensors, to:
retrieve temperature values generated by one or more thermal sensors of the plurality of thermal sensors;
employ the temperature values within a heat-spreading function to determine a time period during which the one or more thermal sensors are to be deactivated; and
deactivate the one or more thermal sensors for the time period.

2. The integrated circuit of claim 1, wherein, in response to expiration of the time period, the control logic is to reactivate the one or more thermal sensors to wait for a subsequent thermal read operation.

3. The integrated circuit of claim 1, wherein the heat-spreading function is:
to model characteristics of silicon temperature expansion that include a time constant of thermal conductivity for silicon; and
configured to output the time period that, in response to a failure of thermal control, would pass before a temperature sensed by the one or more thermal sensors reaches a threshold value that exceeds a normal operating temperature.

4. The integrated circuit of claim 3, wherein the control logic is programmable to set the threshold value based on one of a danger region associated with a thermal alert or a forbidden region associated with a final thermal threshold.

5. The integrated circuit of claim 1, wherein the heat-spreading function is one of a linear extrapolation that employs a single thermal time constant, a piecewise linear function that employs multiple thermal time constants for different temperature regions, or an explicit continuous function that tracks a non-linear path between temperature and time.

6. The integrated circuit of claim 1, wherein the control logic is further to store the time period, associated with the one or more thermal sensors, in memory to be accessed during deactivation of the one or more thermal sensors.

7. The integrated circuit of claim 1, wherein the control logic is further to:
continue to retrieve the temperature values from one or more thermal sensors of the plurality of thermal sensors;
continue to employ the temperature values in the heat-spreading function to determine an updated time period; and
continuously cycle the plurality of thermal sensors between being deactivated and being reactivated based on the updated time period.

8. The integrated circuit of claim 7, wherein the updated time period is to range within a plurality of milliseconds while time spent being reactivated is to range within a plurality of microseconds to perform thermal read operations.

9. A system comprising:
a plurality of thermal sensors integrated within digital domain circuitry of an integrated circuit die; and
a thermal controller, coupled to the plurality of thermal sensors, to:
retrieve a plurality of temperature values from a group of co-located thermal sensors of the plurality of thermal sensors;
determine an average value of the plurality of temperature values;
employ the average value within a heat-spreading function to determine a time period during which the group of co-located thermal sensors are to be deactivated; and
deactivate the group of co-located thermal sensors for the time period.

10. The system of claim 9, wherein the thermal controller is further to, in response to expiration of the time period, reactivate the group of co-located thermal sensors to wait for a subsequent thermal read operation.

11. The system of claim 9, wherein the heat-spreading function is configured to output the time period that, in response to a failure of thermal control, would pass before a temperature sensed by the group of co-located thermal sensors reaches a threshold value that exceeds a normal operating temperature.

12. The system of claim 11, wherein the thermal controller is programmable to set the threshold value based on one of a danger region associated with a thermal alert or a forbidden region associated with a final thermal threshold.

13. The system of claim 9, wherein the heat-spreading function is one of a linear extrapolation that employs a single thermal time constant, a piecewise linear function that employs multiple thermal time constants for different temperature regions, or an explicit continuous function that tracks a non-linear path between temperature and time.

14. The system of claim 9, wherein the thermal controller is further to store the time period, associated with the group of co-located thermal sensors, in memory to be accessed during deactivation of the group of co-located thermal sensors.

15. The system of claim 9, wherein the thermal controller is further to:
continue to retrieve the plurality of temperature values from one or more thermal sensors of the plurality of thermal sensors;
continue to employ the average value, of the plurality of temperature values, in the heat-spreading function to determine an updated time period; and
continuously cycle the group of co-located thermal sensors between being deactivated and being reactivated based on the updated time period.

16. The system of claim 15, wherein the updated time period is to range within a plurality of milliseconds while time spent being reactivated is to range within a plurality of microseconds to perform thermal read operations.

17. A method comprising:
receiving temperature values generated by one or more thermal sensors of a plurality of thermal sensors integrated within digital domain circuitry on an integrated circuit;
determining, based at least on the received temperature values, a time period during which the one or more thermal sensors are to be deactivated; and
causing the one or more thermal sensors to be deactivated for the time period.

18. The method of claim 17, further comprising, in response to expiration of the time period, causing the one or more thermal sensors to wait for a subsequent thermal read operation before being reactivated.

19. The method of claim 17, wherein the determining comprises employing the temperature values within a heat-spreading function to determine the time period, the method further comprising:
configuring the heat-spreading function to output the time period that, in response to a failure of thermal control, would pass before a temperature sensed by the one or more thermal sensors reaches a threshold value that exceeds a normal operating temperature; and
making the threshold value selectable between one of a danger region associated with a thermal alert or a forbidden region associated with a final thermal threshold.

20. The method of claim 17, further comprising;
continuing to receive the temperature values from one or more thermal sensors of the plurality of thermal sensors;
continuing to determine an updated time period based at least on the received temperature values; and
continuously cycling the plurality of thermal sensors between being deactivated and being reactivated based on the updated time period.

21. The method of claim 17, wherein the one or more thermal sensors comprise a group of co-located thermal sensors, the method further comprising:
determining an average value of the temperature values; and
determining the time period, based at least on the average value, during which the group of co-located thermal sensors are to be deactivated.

22. A communication system for high-speed network communication, the communication system comprising:
a network interface;
a processing unit coupled to the network interface and configured to transmit and receive data through the network interface;
a plurality of thermal sensors integrated within digital domain circuitry, to include circuitry of the network interface and the processing unit; and
a thermal controller, coupled to the plurality of thermal sensors, to:
retrieve temperature values generated by one or more thermal sensors of the plurality of thermal sensors;
employ the temperature values within a heat-spreading function to determine a time period during which the one or more thermal sensors are to be deactivated; and
deactivate the one or more thermal sensors for the time period.
